(19) United States
(12) Patent Application Publication
(10) Pub. No.: US 2022/0055859 A1
(43) Pub. Date: Feb. 24, 2022

(54) METHOD FOR EXCHANGING A COMPONENT IN A PASSENGER TRANSPORT SYSTEM AND DEVICE TO BE USED IN SAID METHOD

(71) Applicant: INVENTIO AG, Hergiswil (CH)

(72) Inventors: Jürg BURRI, Hirschthal (CH); Thomas NOVACEK, Schwechat (AT)

(21) Appl. No.: 17/309,655

(22) PCT Filed: Dec. 2, 2019
(86) PCT No.: PCT/EP2019/083276

§ 371 Date: Jun. 11, 2021

(30) Foreign Application Priority Data
Dec. 12, 2018 (EP) 18211944.6

(51) Int. Cl. B66B 1/34

(52) U.S. Cl. CPC B66B 1/343; B66B 1/3407; B66B 1/3446

(57) ABSTRACT

A method and a corresponding device for exchanging a component in a passenger transport system are proposed. In this case, a digital double dataset, which is digitally stored in a computer and can also be processed, exists parallel to the passenger transport system, wherein said digital double dataset comprises data concerning physical properties of the passenger transport system. The method comprises the steps of physically exchanging the component by removing an existing component from the passenger transport system and replacing the existing component with a replacement component; and exchanging component data concerning physical properties of the component in an at least partially automated manner by replacing component data concerning physical properties of the existing component with component data concerning physical properties of the replacement component in the digital double dataset.

### TECHNICAL FIELD

The present disclosure pertains to a method for exchanging a component in a passenger transport system. The disclosure also pertains to a method for monitoring current physical properties of a passenger transport system. The disclosure furthermore pertains to a device and a computer program product, which particularly can be used in the course of carrying out the inventive method, as well as to machine-readable medium for storing the computer program product.

### SUMMARY

Passenger transport systems such as elevators, escalators or moving walkways serve for transporting persons within a building. A passenger transport system consists of a plurality of components. Each of the components has characteristic physical properties. In this case, the components interact with one another and/or adjacent components may be fastened on one another. The physical properties of all components, as well as the manner in which these components interact, generally define the physical properties of the entire passenger transport system.

The physical properties of a passenger transport system can change over time, for example, due to wear on the components. This can affect the operation of the passenger transport system and even lead to defects or malfunctions.

Until now, a current state of a passenger transport system, which is defined by the physical properties, had to be monitored within certain time intervals in order to detect excessive wear or the like in a timely manner and to allow corresponding servicing of the passenger transport system. In most instances, this was usually realized in that a technician inspected the passenger transport system on site. It was alternatively or additionally possible to provide technical precautions such as sensors on the passenger transport system, wherein said sensors made it possible, for example, to monitor a current state of the passenger transport system from a remote monitoring center.

Modern computer technology, as well as corresponding computer simulations or computer models, make it possible to monitor the physical properties of a passenger transport system in a different way. In this case, the physical properties of a passenger transport system are recorded as detailed as possible in an initial stage, e.g., directly after the complete installation of the passenger transport system in a building, and stored in a computer. The thusly stored data is sometimes also referred to as digital double dataset (or digital double or digital twin for short). A sum of this data not only corresponds to an inventory of sorts prior to the start-up of the passenger transport system, but may also serve as a basis for computer simulations or computer models for determining changes in the physical properties of the passenger transport system that occur over time. This data has such a high quality that the entire physical passenger transport system can also be displayed on a computer screen in the form of a virtual three-dimensional representation, which furthermore can be dynamically animated. In this way, the state of the passenger transport system can be monitored based on data processing of the digital double dataset only or used for at least assisting in on-site monitoring. The effort required for monitoring and servicing passenger transport systems can thereby be significantly reduced. Such digital twins are described, for example, in US2017/0286572 A1 and US2016/0247129 A1.

However, it was observed that monitoring of the state of a passenger transport system based on a digital double dataset, in which data concerning prevailing physical properties of the passenger transport system in an initial stage is stored, does not always lead to satisfactory results.

Among other things, there may be a need for making available a method and a device for exchanging a component in a passenger transport system, in which the corresponding digital double dataset can be updated with respect to its data in accordance with the state of the passenger transport system in a simpler and more reliable manner, as well as with fewer data storage and processor resources. There may also be a need for a corresponding computer program product, as well as a machine-readable medium for storing this computer program product.

Such a need can be met with the object according to embodiments of the disclosure. Advantageous embodiments are defined throughout.

According to a first aspect of the disclosure, a method for exchanging a component in a passenger transport system is proposed. In this case, a digital double dataset, which comprises data concerning physical properties of the passenger transport system and can be digitally processed in a computer, exists parallel to the passenger transport system. The digital double dataset may be digitally stored in a computer or on a machine-readable medium. The method comprises at least the following process steps, which are potentially, but not necessarily, carried out in the cited sequence:
physically exchanging the component by removing an existing component from the passenger transport system and replacing the existing component with a replacement component; and
exchanging component data concerning physical properties of the component in an at least partially automated manner by replacing component data concerning physical properties of the existing component with component data concerning physical properties of the replacement component in the digital double dataset. In this case, the digital double dataset is composed of a plurality of component dataset modules, wherein each of these component dataset modules respectively describes component data concerning physical properties of one of the components in the passenger transport system, and wherein an entire component dataset module is respectively replaced in the digital double dataset during an exchange of component data.

In other words, the associated component dataset module is also replaced during an exchange of a physical component. To this end, the physical properties acquired on the physical replacement part directly after its manufacture are combined in a corresponding component model dataset. Subsequently, this component model dataset can be incorporated into the digital double dataset without elaborate modifications and thereby completely replaces all physical properties of the removed physical component. In this way, transmission errors can be effectively prevented during the maintenance of the digital double dataset. A particular advantage of this digital double dataset, which is structured by means of component dataset modules, can also be seen in that it allows a positive identification of a component detected based on the simulation results. In other words, the aforementioned structuring makes it possible to respectively reduce the simulation to the individual component and its component dataset module without ignoring the effect of adjacently arranged components. Consequently, the failing component can be directly identified and output and the method is not merely limited to the output of a list of the involved components as it is the case in US2017/0286572 A1.

According to a second aspect of the disclosure, a method for monitoring current physical properties of a passenger transport system is proposed. In this case, initial physical properties of the passenger transport system are specified in a computer in a digitally stored digital double dataset that can also be processed. The current physical properties of the passenger transport system are determined by means of calculations, simulations and/or models based on the initial physical properties specified in the digital double dataset. In this case, individual components of the passenger transport system are exchanged by means of a method according to an embodiment of the first aspect of the disclosure.

According to a third aspect of the disclosure, a device for updating a digital double dataset in the course of carrying out a method according to an embodiment of the first or second aspect of the disclosure is proposed. In this case, the digital double dataset comprises data concerning physical properties of a passenger transport system. The device is configured in such a way that, during a physical exchange of a component by removing an existing component from the passenger transport system and replacing the existing component with a replacement component, data concerning physical properties of the component is exchanged in an at least partially automated manner in dialogue with the individual carrying out the method on the passenger transport system by replacing component data concerning physical properties of the existing component with component data concerning physical properties of the replacement component in the digital double dataset. In order to ensure the data quality during the replacement, the digital double dataset is composed of a plurality of component dataset modules, wherein each of these component dataset modules respectively describes component data concerning physical properties of one of the components in the passenger transport system, and wherein an entire component dataset module is respectively replaced in the digital double dataset during an exchange of component data.

For example, the individual carrying out the method may be a member of the service personnel, but also a service robot or the like. The individuals carrying out the method generically carry along corresponding electronic apparatuses and interfaces such as mobile telephones, tablets, laptops, wire-bound or wireless transmission means and the like, by means of which data can be retrieved from and transmitted to the digital double dataset.

According to a fourth aspect of the disclosure, a computer program product with machine-readable instructions is proposed, upon the execution of which a computer is instructed to carry out process steps of a method according to an embodiment of the first or second aspect of the disclosure, which effect the exchange of the component data in the digital double dataset.

According to a fifth aspect of the disclosure, a machine-readable medium with a computer program product according to an embodiment of the fourth aspect of the disclosure stored thereon is proposed.

Potential characteristics and advantages of embodiments of the disclosure may, among other things, be considered as being based on the ideas and realizations described below without thereby restricting the disclosure.

Passenger transport systems such as elevators, escalators and moving walkways generally are custom-made systems. This means that each passenger transport system typically is designed specifically for the tasks to be fulfilled. In this context, prevailing conditions in a building accommodating the passenger transport system particularly are taken into account. Consequently, there is much variance in designing and commissioning a passenger transport system because different components and/or different numbers of components can be used for each individual passenger transport system. For example, the components to be used in an escalator or a moving walkway depend, among other things, on the length to be bridged by the escalator/moving walkway, on a specified transport capacity, on load-carrying capacities and bearing strengths within a building, etc. Similarly, the components to be used in an elevator depend, among other things, on the number of floors to be serviced by the elevator, specified transport capacities, load-carrying capacities and bearing strengths within the building, etc. Regulations and laws that differ locally, e.g., nationally or regionally, may also affect the selection of the components to be used. Furthermore, individual customer requests can affect the concrete design of a passenger transport system.

Due to the plurality of potential designs of passenger transport systems and the components used therein, the process of monitoring the state of a passenger transport system may become particularly elaborate. Until now, well-trained service personnel and/or a plurality of different sensors typically had to be used within the passenger transport system in order to reliably monitor the current state of the passenger transport system.

Furthermore, passenger transport systems are immobile after their installation. This means that service personnel has to drive to a passenger transport system to be serviced in order to inspect its state on site or that signals delivered by sensors have to be transmitted, e.g., to a monitoring center, in order to be analyzed. This can involve a significant effort for monitoring the passenger transport system.

On the other hand, passenger transport systems serve for transporting people and therefore always have to operate safely. Continuous monitoring of the state of a passenger transport system to the effect that the physical properties prevailing therein ensure a safe operation therefore is absolutely imperative.

As already indicated initially, the state of a passenger transport system can be advantageously monitored with little effort by using the data of a digital double. In this respect, the applicant of the present patent application has already submitted prior patent applications with the application number EP 17207385 and the title “Method and Device for Monitoring a State of a Passenger Transport System by Using a Digital Double” and with the application number EP 17 207 399 and the title “Method and Device for Commissioning a Passenger Transport System to be Manufactured by Creating a Digital Double.” Details on how a digital double dataset can be recorded and which data may be contained therein, as well as on how the state of a passenger transport system can be monitored or the passenger transport system can be commissioned based thereon, are explicitly described in these prior patent applications. Properties and details described in the prior patent applications may also be partially applied or transferred to the methods and devices described in the present patent application. The content of the prior patent applications is hereby incorporated into the present patent application in its entirety.

Information on changes in the physical properties of the passenger transport system that occur over time can be determined based on a previously recorded digital double dataset by means of suitable data processing in a computer. For example, a computer used for this purpose may be located in a monitoring center, e.g., remotely from the passenger transport system to be monitored.

This makes it possible to derive information on a state of the passenger transport system that changes over time, wherein said information can be used, e.g., for assisting in or simplifying current or future service procedures.

The data contained in the digital double dataset may reflect the actual physical properties of the components used in the finished and installed passenger transport system. In this context, the data may describe different physical properties such as mechanical properties, electrical properties, magnetic properties, thermal properties, etc. The data may describe, for example, dimensions of a component in different directions in space and therefore reflect a geometry of the respective component. Furthermore, the data may reflect information, for example, on materials used, electrical and/or thermal conductivities and many other properties. The digital double may therefore be considered as a virtual image of the finished passenger transport system or the components contained therein. The data contained in the digital double dataset should reflect the physical properties of the components in a sufficiently detailed manner in order to make it possible to derive information on current structural and/or functional properties of the entire passenger transport system therefrom. The digital double particularly should make it possible to derive information on current structural and/or functional properties, which characterize a current state of the entire passenger transport system and can be used for evaluating its current or future operational safety, its current or future availability and/or a current or future need for service or repair.

However, it was now discovered that a passenger transport system can in the course of its operation be subject to changes, which until now could not be taken into account in the computer simulations or computer models used for monitoring the state of the passenger transport system.

It was particularly discovered that it may become necessary to exchange individual components of a passenger transport system in the course of its operation.

For example, components may have to be exchanged due to wear or occurring defects.

Until now, such an exchange of components in a passenger transport system was not taken into account in the associated digital double. Instead, a physical exchange of a component in the passenger transport system typically did not lead to a change in the associated digital double dataset or it was assumed that the replacement component is identical to the previously existing component and the physical properties of the passenger transport system therefore were not changed due to the exchange.

However, it was now discovered that such simplified procedures or such simplifying assumptions can lead to the real physical properties of the passenger transport system no longer being reflected with sufficient accuracy by the data stored in the digital double dataset in the course of the operation of the passenger transport system and, in particular, after the exchange of one or more components in the passenger transport system.

In the method for exchanging a component in a passenger transport system described herein, it is therefore proposed to also exchange the data, which concerns the physical properties of the exchanged component and is therefore referred to as component data below, in the digital double dataset in addition to the physical exchange of the component. In this case, component data that describes the physical properties of the existing component, e.g., the component that was previously installed in the passenger transport system, is replaced with component data that describes the physical properties of the replacement component.

The physical properties of the existing component and the replacement component particularly may differ due to different degrees of wear on the components. This can be taken into account in the component data to the effect that the physical properties specified therein take into account the respective degree of wear. Alternatively, the component data of a component may describe when the respective component was installed or put into operation such that this information can be taken into account in calculations, simulations and/or models. For example, time-related aging behavior such as increasing embrittlement of polymeric materials over time can be incorporated into the simulations and continuously changed in the corresponding component data such that the damping behavior of the existing component significantly differs from the replacement component.

However, the physical properties of the existing component and the replacement component may also differ with respect to other parameters, for example, because geometric properties of the replacement component, materials used therein or the like were meanwhile modified.

In this case, the exchange of the component data should take place in an at least partially automated manner, preferably in a fully automated manner. In other words, the replacement of the component data concerning the previously existing component with the component data of the replacement component in the digital double dataset should be carried out or at least assisted by automated activities of one or more devices used such that human assistance in this context is not required or at least can be minimized Potential embodiments for implementing such an automation are described further below.

The digital double dataset is composed of a plurality of component dataset modules as already mentioned above. In this case, each component dataset module may respectively describe component data concerning physical properties of one of the components in the passenger transport system.

In other words, the digital double dataset has a modular structure. The digital double dataset consists of a plurality of independent component dataset modules. Each component installed in the respective passenger transport system preferably is provided with its own component dataset module that describes the physical properties of this particular component in the passenger transport system. In this context, this specifically means that at least a few of the physical properties were determined directly on the physical component, for example, by measuring geometric data, and incorporated into the associated component dataset module. Consequently, no two component dataset modules are completely identical, even if their associated physical components were produced according to one and the same specifications and on the same processing machine. Each individual component dataset module forms a self-contained dataset that reflects the physical properties of the component independently of the properties of adjacent components in the passenger transport system.

Due to such a modular approach, individual component dataset modules in the digital double dataset can be exchanged without having to modify other component dataset modules of the entire digital double dataset. In this way, the at least partially automated exchange of component data concerning physical properties of the replacement component can be significantly simplified or is potentially even made possible at all.

According to a concretized embodiment, each component dataset module may comprise component unit data concerning physical properties of the component itself, as well as interface data concerning physical properties that describe a cooperation of the component with other components. In other words, a component dataset module may comprise at least two different types of data.

A first type of data, which is referred to as component unit data herein, describes the physical properties of the component itself, e.g., intrinsic properties of the component as an independent unit. This component unit data characterizes physical properties of the component regardless of how this component cooperates or interacts with other components. Such component unit data may describe, for example, information on a geometry, a structural design, materials used, etc.

A second type of data, which is referred to as interface data herein, describes physical properties of the component, which are influential in the course of a cooperation of the respective component with other components. This interface data therefore can be used for analyzing how the component interacts with adjacent components.

For example, this interface data may contain information on boundary surfaces, along which the component abuts on an adjacent component. Such information may contain, for example, geometric properties of the boundary surfaces, materials used for the boundary surfaces, their mechanical, electrical, thermal and other properties, etc. The interface data particularly may contain information on position coordinates of multiple interfaces or boundary surfaces relative to one another and, if applicable, also information on adjacent components. Among other things, this makes it possible to verify whether the respective component was correctly replaced or installed in the passenger transport system in the course of an exchange.

During the exchange of component data, the modular structure of the digital double dataset is used to the effect that an entire component dataset module is respectively also replaced in the digital double dataset when a physical component is replaced.

In other words, not only individual data concerning the replacement component can be replaced in the digital double dataset when a component in the passenger transport system was physically exchanged, wherein this data may be distributed over the entire digital double dataset and accordingly would have to be located, and wherein it would furthermore have to be checked if all data concerning the replacement component was actually replaced correctly. Instead, the component dataset module associated with the exchanged component can be replaced in its entirety.

Due to the fact that each component dataset module forms a self-contained unit and interactions with adjacent components only manifest themselves based on corresponding effects on the physical properties specified by the interface data, individual component dataset modules can be easily exchanged with little data processing effort.

According to an embodiment, the component data concerning physical properties of the replacement component may also comprise installation data that is affected by the type of installation of the replacement component in the passenger transport system.

In other words, the component data may not only contain physical properties that describe the respective component in the form of an independent element, e.g., regardless of how the component is installed in the passenger transport system, but also physical properties that depend on how the replacement component is installed or integrated into the passenger transport system. The installation data may provide information on how the component was processed or generally modified with respect to its physical properties during the installation. This information makes it possible, for example, to derive how other physical properties of the exchanged component and/or adjacent components have changed or may change in the future due to the installation or due to the effects caused during the installation.

According to an embodiment, the installation data may comprise forces and/or torques that were applied for fixing the replacement component in the passenger transport system during the replacement of the component.

In other words, the installation data may describe forces and/or torques that were exerted upon the replacement component during the exchange of the component and/or upon fixing means used for this purpose in order to attach the replacement component, for example, on adjacent components and to thereby fix the replacement component within the passenger transport system. In this case, the installation data can be associated with the corresponding component dataset modules in the digital double dataset. For example, the installation data may describe contact forces or correlated contact pressures, with which a component is pressed on other components of the passenger transport system during the exchange. For example, the installation data may additionally or alternatively comprise tightening torques that indicate the force, with which a fixing means such as a screw used for fixing the component was tightened during the exchange of the component.

Among other things, installation-related effects, which may reflect the physical properties and functions of the exchanged component itself, as well as its cooperation with other components in the passenger transport system, can be derived from the specified installation data. This makes it possible, for example, to respectively calculate or simulate elastic deformations of the type occurring on the exchanged component, as well as on adjacent components, due to the forces and/or torques applied during the installation.

According to a concrete embodiment, the installation data may be automatically acquired by a tool used for the installation and transmitted to the computer storing the digital double dataset in an automated manner.

In other words, special tools that acquire installation data affecting the physical properties of the exchanged component and forward this installation data to the computer storing the digital double dataset in an automated manner may be used in the course of the physical exchange of a component in a passenger transport system. For example, a tool used for tightening screws may acquire the forces and/or torques applied during the tightening process and forward these forces and/or torques to the aforementioned computer in an automated manner. To this end, a wire-bound or wireless data communication link may be established between the tool and the computer. In the computer, the transmitted installation data preferably can be associated with the currently exchanged component or the component dataset module reflecting the physical properties of this exchanged component in an automated manner. For example, changes in the shape or other physical properties of the exchanged component can once again be calculated or remodeled in a largely automated manner based on this association.

According to an embodiment, the component data concerning a replacement component may be stored in a data storage unit provided on the replacement component. In this case, the component data can be transmitted from this data storage unit to the computer storing the digital double dataset in an automated manner.

In other words, an individual data storage unit may be provided on a component for a passenger transport system. The data storage unit may be permanently attached to the component or at least connected to the component in such a way that it is easily available and readable during the exchange of the component. Component data that concerns the component and characterizes physical properties of this component may be stored in this data storage unit. Component data preferably can be stored in the data storage unit in digital form. The data storage unit may be realized, for example, in the form of an electronic data storage unit, a magnetic data storage unit, an optical data storage unit or the like. Accordingly, the data storage unit can be read out electronically, magnetically, optically or in a different way. A separate readout device may be provided for reading out the component data. For example, this readout device may form part of a tool used for exchanging the component. The readout device may alternatively be realized in the form of a separate unit. During the physical exchange of a component, the component data can be read out from the data storage unit and forwarded to the computer in an automated manner. Alternatively, an installer can use the aforementioned separate unit for reading out and subsequently forwarding the component data to the computer.

According to an alternative embodiment, a unique identification may be provided on the component. The component data concerning the replacement component may be stored in a data storage unit that is arranged remotely from the component. In this case, the component data concerning the replacement component can be transmitted from the data storage unit to the computer storing the digital double dataset in an automated manner by transmitting the identification.

In other words, the component data associated with a specific component potentially can be stored, for example, centrally in a data storage unit for each of a plurality of components. This data storage unit may be located remotely from the passenger transport system. For example, the data storage unit may form part of a data cloud (“cloud”), in which all component data for a plurality of components, which can be used in various passenger transport systems, may be stored.

Each component or each type of component may have a unique identification (ID). For example, this identification may be arranged directly on the component or delivered together with the component. The identification may be provided on the component, for example, in the form of a numerical code or barcode. The identification preferably can be read out in an automated manner, e.g., by machine. During an exchange of a component, the identification of the respective component can be read out and transmitted to the data storage unit storing the component data. The associated component data can then be determined in the data storage unit based on this identification and ultimately transmitted to the computer, in which the digital double dataset is respectively stored and processed.

According to an embodiment, work steps to be carried out while carrying out process steps for the physical exchange of the component may be specified by a computer program with consideration of the component data concerning the component.

In other words, an installer tasked with physically exchanging a component in a passenger transport system can be assisted in that information concerning the work steps to be carried out is transmitted to the installer. The component data of the component to be exchanged can be taken into account when this information is generated. This component data can be respectively retrieved or derived from the digital double dataset.

To this end, it would be possible, for example, to provide a computer program that is configured for detecting that a component of the passenger transport system should be exchanged and for subsequently generating a suitable information output in order to suitably assist the installer carrying out the exchange. The detection of a required component exchange may take place in an automated manner, for example, based on a current analysis of the digital double and/or based on sensors signals of sensors that respectively monitor a state of the passenger transport system or the component. This detection may alternatively also take place as a result of a suitable input by the installer. Subsequently, the component data associated with the component to be exchanged can be accessed by means of the computer program. The information to be provided to the installer can then be derived based on this component data. For example, the component data may be analyzed by the computer program itself in order to determine the work steps required for the exchange of the component. Information on the work steps to be carried out may alternatively be derived from a supplementary database with consideration of the component data. For example, the information on the work steps to be carried out can be perceived visually, for example, in the form of an output on a display, or perceived acoustically, for example, in the form of an output by means of a loudspeaker.

The output of information concerning work steps to be carried out in order to exchange a component can significantly reduce the risk of faulty installation processes. In addition, the quality of the installation can be simulated and monitored one-to-one due to the feedback of the installation data.

According to an embodiment of the disclosure, actual data concerning currently prevailing physical properties of the passenger transport system can be determined during the method proposed herein and associated data in the digital double dataset can be replaced with the actual data.

In other words, not only the component data concerning the component to be exchanged can be replaced in the digital double dataset during the exchange of a component in the passenger transport system, but other data in the digital double dataset can also be updated. In this case, it is possible to take advantage of the fact that an installer is present in the passenger transport system anyway in order to exchange the aforementioned component. Consequently, the installer can carry out or initiate additional measures on site in order to determine how physical properties of the passenger transport system or its components have changed, for example, since the installation or since the last inspection.

For example, the installer can measure current physical properties of components or prompt correspondingly provided sensors to carry out such measurements. The thusly obtained actual data therefore represents actual, current physical properties of the components and can replace associated data in the digital double dataset, which describes the previously prevailing physical properties of these components. In this way, the digital double dataset can be updated and its reliability therefore can be improved to the effect that information on a current state of the passenger transport system derived from the digital double dataset has a higher probability of being correct.

All in all, embodiments of the described method according to the first aspect of the disclosure for exchanging a component in a passenger transport system allow superior monitoring of current physical properties of the passenger transport system in the course of an embodiment of the method according to the second aspect of the disclosure. In other words, methods for monitoring a state of a passenger transport system, which utilize a digital double in order to derive information on current physical properties of the passenger transport system from data concerning initial physical properties of the passenger transport system stored in the digital double dataset, can be improved in that the associated component data in the corresponding digital double dataset is also exchanged when a component in the passenger transport system is exchanged. Since the digital double dataset is thereby kept up to date and can reflect the real conditions in the passenger transport system, reliable information on changes in physical properties of the passenger transport system can be derived from this digital double dataset.

Embodiments of the device for updating a digital double dataset according to the third aspect of the disclosure may employ a computer. The digital double dataset can be stored and processed in this computer. In this case, the device may be configured for detecting when a component in the passenger transport system is exchanged. This takes place in dialogue with the individual carrying out the method on the passenger transport system. This means that different information, e.g., time information (this may also be the start time for exchanging the component data when the new component is installed), confirmation information of the installer or service robot, torques measured during the installation, feedbacks from the device to the installer or service robot, requests for inputting certain information or acquiring measuring values, etc., is exchanged between the device and the apparatuses and persons involved in carrying out the method. The device can then determine the identity of the exchanged component and read out the component data concerning the replacement component, for example, from a data storage unit, in an at least partially or preferably fully automated manner. Subsequently, the device can once again incorporate this component data concerning the replacement component into the digital double dataset as a replacement for the corresponding component data concerning the originally existing component in an at least partially or preferably fully automated manner. In this case, the desired automation can be implemented with suitable hardware, for example, in the form of sensors, scanners, cameras, etc. and/or suitable software.

Software in the form of a computer program product according to the fourth aspect of the disclosure particularly may be used in this case, wherein said computer program product contains machine-readable instructions, upon the execution of which a computer is instructed to respectively carry out or control process steps of a method according to the first or second aspect of the disclosure, which effect the exchange of the component data in the digital double dataset. Such a computer program product may be formulated in any computer language.

The computer program product may be stored on any machine-readable medium. For example, such a medium may be a CD, a DVD, a flash memory or a similar, preferably portable data storage medium. The storage on a storage medium of a control of the passenger transport system is also possible. Such a medium may alternatively form part of a computer, on which data is stored and from which data can be downloaded. For example, such a computer may be a server or part of a data cloud (cloud), wherein data can be downloaded, for example, via a network, particularly via the Internet.

It should be noted that a few of the potential characteristics and advantages of the disclosure are described herein with reference to different embodiments. Characteristics and advantages particularly are partially described with reference to embodiments of the method for exchanging a component and partially with reference to a method for monitoring current physical properties of a passenger transport system or to a device, by means of which corresponding process steps are carried out. A person skilled in the art can easily see that the characteristics can be suitably combined, adapted or interchanged in order to arrive at other embodiments of the disclosure.

### BRIEF DESCRIPTION OF THE DRAWINGS

Embodiments of the disclosure are described below with reference to the attached drawings, wherein neither the drawings nor the description should be interpreted as restrictions of the disclosure.

FIG. 1 shows a highly schematic representation of a passenger transport system consisting of multiple physical components.

FIG. 2 shows a digital double dataset that forms a virtual electronic image of the passenger transport system illustrated in FIG. 1.

The figures are merely schematic and not true-to-scale. Identical or identically acting characteristics are identified by the same reference symbols in the different figures.

### DETAILED DESCRIPTION

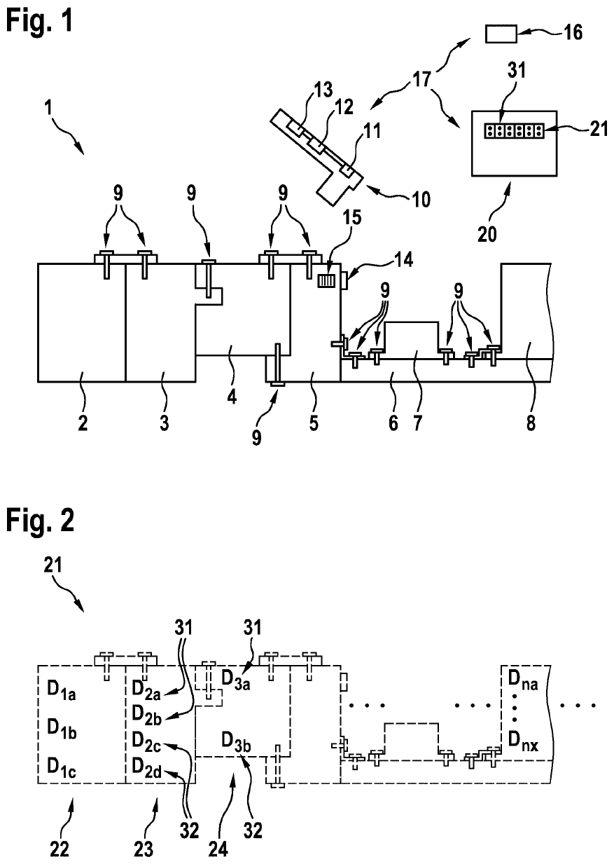

FIG. 1 shows a simplified representation of a passenger transport system 1 with components 2 to 8 installed therein. In this case, the passenger transport system 1, as well as the components 2 to 8, are merely illustrated in a highly schematic manner because the concrete illustration of the passenger transport system 1 and its components is not important for understanding the present disclosure. For example, the passenger transport system specifically may be an escalator or moving walkway and its component may be typical components of such an escalator or such a moving walkway, e.g., step elements, pallet elements, elements of a conveyor chain, drive elements, elements of a supporting framework, etc. Alternatively, the passenger transport system may be an elevator and its components may form part of an elevator cabin, a counterweight, guide rails, fixing elements, a drive, multiple cable-like or belt-like suspension means, elevator doors, etc. In this case, the individual components 2 to 8 may be fastened on one another and/or on supporting structures within the passenger transport system 1 by means of fastening means 9 such as screws.

Physical properties of the components 2 to 8 of the passenger transport system can be determined during its planning, commissioning and/or completion. The thusly obtained information may be stored in the form of component data 31 in a digital double dataset 21. For example, the digital double dataset 21 may be stored in a storage unit of a computer 20. This computer 20 may be located remotely from the passenger transport system 1.

FIG. 2 shows a schematic representation of a digital double dataset 21. In this case, the digital double dataset 21 is composed of a plurality of individual component dataset modules 22, 23, 24. Each of these component dataset modules 22, 23, 24 contains component data 31 concerning physical properties Dla, Dlb, Dlc, D2a, D2b, . . . , Dna, . . . , Dnx of an associated component 2 to 8. Since these component dataset modules 22, 23, 24 concern datasets, by means of which a virtual three-dimensional image of the passenger transport system 1 according to FIG. 1 can be displayed, for example, on the screen of the computer 20, these component dataset modules 22, 23, 24 in fact have the same shape as their physical equivalents, but are illustrated with broken lines. For example, the component data 31 may contain information on a geometry, materials used and/or other physical properties Dna, . . . , Dnx of the associated component 2 to 8. Furthermore, other physical properties Dna, . . . , Dnx such as installation data 32 may be stored in a component dataset module 22, 23, 24. This installation data 32 refers to the type of installation of a component 2 to 8 in the passenger transport system 1. For example, the installation data 32 may contain information on torques D2c, D2d, D3d, with which the fastening elements 9 in the form of screws were tightened during the installation.

A state of the passenger transport system 1 can be monitored with the aid of the digital double dataset 21. To this end, information on changes in the physical properties Dna, . . . , Dnx of the passenger transport system 1 and its components 2 to 8, which occur over time, can be determined based on the component data 31 and installation data 32 contained in the digital double dataset 21 with the aid of computer simulations and/or computer models.

If components 2 to 8 are exchanged when the passenger transport system 1 is serviced, a few of the characteristic physical properties of these components typically change. Consequently, these changes should also be updated in the digital double dataset 21, which exists parallel to the passenger transport system 1 and can be used as simulation environment, for example, for monitoring the passenger transport system 1 and/or for preparing a proactive service schedule therefrom.

Embodiments of the present disclosure propose that, during a physical exchange of one of the components 2 to 8 in the passenger transport system 1, the component dataset module 22, 23, 24 associated with the respective component is also exchanged. In this case, component data 31 concerning the replacement component 2 to 8 is stored in the replacement component dataset module 22, 23, 24. This component data may comprise component unit data that describes physical properties Dna, . . . , Dnx of the component itself, as well as interface data Dna, . . . , Dnx that describes physical properties regarding a cooperation of the component with other components.

It is preferably possible to operate with different versions (releases) of the digital double dataset 21, wherein the last state of the “old version” can be frozen and a “new version” can be generated from the “old version” by replacing the respective component dataset module 22, 23, 24 of the exchanged component 2 to 8.

Installation data such as tightening torques of screws or other fastening means 9 can also be incorporated in this case. To this end, it would be possible, for example, to use a tool 10 that is equipped with a sensor 11. Measurement data regarding forces and torques applied during the installation, which is acquired by the sensor 11, can be evaluated in an evaluation unit 12 in the tool 10 and then transmitted, for example, in a wireless manner, to the computer 20 that stores and processes the digital double dataset 21. The thusly transmitted installation data 32 can be associated, for example, with a virtual model of the fastening means 9 or specifically the screw in the digital double dataset 21. The installation data 32 may alternatively also be input by an installer or adopted from a previously used screw, but this leads to a reduced data quality in the digital double dataset 21. It is preferred that such characteristic physical data Dna, . . . , Dnx can be correspondingly identified, e.g., it can be specified whether it was adopted, measured or input. A subsequent error analysis can thereby be simplified.

A prerequisite for carrying out the method proposed herein is a digital double dataset 21, which analogous to the physical passenger transport system 1 is composed of separate or separable component dataset modules 22, 23, 24 that are virtually connected to one another by interface data. In this case, the interface data may describe interface information such as coordinates in a three-dimensional space.

Multiple options are conceivable for replacing individual component dataset modules 22, 23, 24 with the component data 31 and optional installation data 32 contained therein. For example, data may be incorporated into the digital double dataset 21 in an automated manner by adopting new component dataset modules 22, 23, 24 with characteristic physical properties Dna, . . . Dnx during an order of the already manufactured and stocked replacement component. The new version of the digital double dataset 21 should be released by an installer, wherein installation data should optionally be acquired and input.

Depending on its design, a physical replacement component may comprise, for example, a local data storage unit 14 in the form of a chip with data stored thereon, wherein said data can be read out, for example, by a tool 10 and automatically adopted into the digital double dataset 21.

It would alternatively be conceivable that an identification 15 in the form of a serial number or a machine-readable code is provided on or with the replacement component and a data file containing component data with information regarding the physical properties Dna, . . . , Dnx of the replacement component is stored on a computer or in a data cloud that acts as remote data storage unit 16. When the replacement component is installed, for example, by the installer, the serial number or the code can be acquired and the associated dataset can thereby be retrieved from the computer or the data cloud (cloud) acting as remote data storage unit 16 and adopted into the digital double dataset 21.

The specially designed tool 10 may form a device 17 together with the computer 20 storing the digital double dataset 21 and, if applicable, the remote data storage unit 16, wherein the digital double dataset 21 can be updated with the aid of said device in the course of an exchange of components 2 to 8 in the passenger transport system 1.

As an alternative to this procedure, the characteristic physical properties Dna, . . . , Dnx of the replacement component may be scanned, for example, on the construction site, and this component data may optionally be supplemented with additional component such as material data. After the transmission of this component dataset module 22, 23, 24 to the computer 20 and its replacing incorporation into the digital double dataset 21, a new version can be generated and subsequently released by the installer.

The removal of an existing component 2 to 8 and the subsequent installation of a replacement component may be accompanied by a computer, for example, in the form of a laptop, a tablet, a mobile telephone, VR goggles or the like, which can access component data 31 of the digital double dataset 21. In this case, it would be possible to provide an installation program that specifies installation steps by accessing involved component dataset modules 22, 23, 24 in the digital double dataset 21.

As a supplement, different verification routines may be carried out. For example, a comparison of identification numbers, a confirmation by the installer or the like may be respectively required or checked. Error messages can optionally be generated.

In conclusion, it should be noted that terms such as “having,” “comprising,” etc. do not preclude any other elements or steps and that terms such as “a” or “an” do not preclude a plurality. It should furthermore be noted that characteristics or steps, which were described above with reference to one of the exemplary embodiments, can also be used in combination with other characteristics or steps of other above-described exemplary embodiments. The reference symbols in the claims should not be interpreted in a restrictive sense.

1-13. (canceled)

14. A method for exchanging a component in a passenger transport system, wherein a digital double dataset representative of the passenger transport system is digitally stored in a computer system or on a machine-readable medium and can be processed by a computer system, wherein said digital double dataset comprises data concerning physical properties of the passenger transport system, the method comprising:
physically exchanging the component by removing an existing component from the passenger transport system and replacing the existing component with a replacement component;
wherein component data concerning physical properties of the component is exchanged in an at least partially automated manner by replacing component data concerning physical properties of the existing component with component data concerning physical properties of the replacement component in the digital double dataset,
wherein the digital double dataset comprises a plurality of component dataset modules, wherein each of these component dataset modules respectively describes component data concerning physical properties of one of the components in the passenger transport system, wherein the physical properties described in the component data take into account the respective degree of wear of the existing component, which degree of wear can be determined by sensors integrated into the passenger transport system, wherein an entire component dataset module is respectively replaced in the digital double dataset during an exchange of component data, and wherein the simulations can be respectively broken down to the individual component or its component dataset module by a current analysis of the digital double dataset, as well as due to the aforementioned structuring of the digital double dataset by means of component dataset modules, and the failing physical component can thereby be directly identified.

15. The method according to claim 14, wherein each component dataset module comprises component unit data concerning physical properties of the component itself, as well as interface data concerning physical properties that describe a cooperation of the component with other components.

16. The method according to claim 14, wherein the component data concerning physical properties of the replacement component also comprises installation data that is affected by the type of installation of the replacement component in the passenger transport system.

17. The method according to claim 16, wherein the installation data comprises forces and/or torques that were applied for fixing the replacement component in the passenger transport system during the replacement of the component.

18. The method according to claim 16, wherein the installation data is automatically acquired by a tool used for the installation and transmitted in an automated manner to the computer system that stores the digital double dataset.

19. The method according to claim 14, wherein the component data concerning a replacement component is stored in a data storage unit provided on the replacement component and transmitted in an automated manner to the computer, storing the digital double dataset.

20. The method according to claim 14, wherein a unique identification is provided on the component and the component data concerning the replacement component is stored in a data storage unit that is arranged remotely from the component, and wherein the component data concerning the replacement component is transmitted from the data storage unit to the computer storing the digital double dataset in an automated manner by transmitting the identification.

21. The method according to claim 14, wherein work steps to be carried out for the physical exchange of the component are specified by a computer program with consideration of the component data concerning the component.

22. The method according to claim 14, wherein actual data concerning currently prevailing physical properties of the passenger transport system is acquired during the method and associated data in the digital double dataset is replaced with the actual data.

23. A method for monitoring current physical properties of a passenger transport system, wherein initial physical properties of the passenger transport system are specified in a computer in a digitally stored digital double dataset that can also be processed, wherein the current physical properties of the passenger transport system are determined by means of calculations, simulations and/or models based on the initial physical properties specified in the digital double dataset, and wherein individual components of the passenger transport system are exchanged by means of a method according to one of the preceding claims.

24. A computer program product with machine-readable instructions, upon the execution of which a computer system is instructed to carry out or control process steps of the method of claim 14, which effect the exchange of the component data in the digital double dataset.

25. A machine-readable medium with a computer program product according to claim 24 stored thereon.
